(19) United States
(12) Patent Application Publication
(10) Pub. No.: US 2023/0028401 A1
(43) Pub. Date: Jan. 26, 2023

(54) NONAQUEOUS ELECTROLYTE ENERGY STORAGE DEVICE AND METHOD FOR MANUFACTURING THE SAME

(71) Applicant: GS YUASA INTERNATIONAL LTD., Kyoto-shi, Kyoto (JP)

(72) Inventor: Masaki YAMAKAJI, Kyoto-shi, Kyoto (JP)

(21) Appl. No.: 17/784,803

(22) PCT Filed: Oct. 7, 2020
(86) PCT No.: PCT/JP2020/037933

§ 371 Date: Jun. 13, 2022

(30) Foreign Application Priority Data
Dec. 17, 2019 (JP) 2019-227631
Dec. 17, 2019 (JP) 2019-227638

(51) Int. Cl. H01M 4/40; H01M 10/0525; H01M 10/0569; H01M 4/505; H01M 4/525; H01M 10/0587

(52) U.S. Cl. CPC H01M 4/405; H01M 10/0525; H01M 10/0569; H01M 4/505; H01M 4/525; H01M 10/0587

(57) ABSTRACT

An aspect of the present invention is a nonaqueous electrolyte energy storage device that includes a negative electrode including a lithium alloy and a nonaqueous electrolyte containing a fluorinated solvent, in which the lithium alloy contains silver, and the content of silver with respect to the total content of lithium and silver in the lithium alloy is 3% by mass or more and 20% by mass or less. Another aspect of the present invention is a nonaqueous electrolyte energy storage device that includes a negative electrode including a lithium alloy and a nonaqueous electrolyte including a lithium salt containing fluorine, in which the lithium alloy contains silver, and the content of silver with respect to the total content of lithium and silver in the lithium alloy is 3% by mass or more and 20% by mass or less.

### TECHNICAL FIELD

The present invention relates to a nonaqueous electrolyte energy storage device and a method for manufacturing the same.

### BACKGROUND ART

Nonaqueous electrolyte secondary batteries typified by lithium ion secondary batteries are widely used for electronic devices such as personal computers and communication terminals, motor vehicles, and the like since these secondary batteries have a high energy density. The nonaqueous electrolyte secondary batteries generally include a pair of electrodes, which are electrically separated from each other by a separator, and a nonaqueous electrolyte interposed between the electrodes, and are configured to allow ions to be transferred between the two electrodes for charge-discharge. Capacitors such as lithium ion capacitors and electric double-layer capacitors are also widely used as nonaqueous electrolyte energy storage devices other than nonaqueous electrolyte secondary batteries.

Metal lithium is known as a negative active material with a high energy density for use in nonaqueous electrolyte energy storage devices. However, in a nonaqueous electrolyte energy storage device in which metal lithium is used for a negative active material, metal lithium may be precipitated in a dendritic form at the surface of the negative electrode during charge (hereinafter, metal lithium in a dendritic form is referred to as a “dendrite”). When the dendrite grows, penetrates a separator, and then comes into contact with a positive electrode, a short circuit is caused. For this reason, a nonaqueous electrolyte energy storage device including metal lithium as a negative active material has the disadvantage that a short circuit is likely to be caused by repeating charge-discharge. As a technique for suppressing the growth of the dendrite, the use of a lithium alloy for a negative active material has been proposed (see Patent Documents 1 to 3).

Specifically, Patent Document 1 describes the invention of a nonaqueous electrolyte solution secondary battery characterized in that a negative electrode is an alloy in solid solution of; lithium; and a metal capable of dissolution in lithium as a solid solution. In examples of Patent Document 1, zinc, magnesium, and silver are used as a metal capable of dissolution in lithium as a solid solution, with the result that charge-discharge cycle characteristics are similarly improved in each case of the lithium alloys used. In the examples of Patent Document 1, a mixed solvent of propylene carbonate and 1,2-dimethoxyethane that are equal in volume is used as a nonaqueous solvent. In addition, in the examples of Patent Document 1, a nonaqueous electrolyte solution with a lithium perchlorate dissolved in the mixed solvent of propylene carbonate and 1,2-dimethoxyethane that are equal in volume is used as a nonaqueous electrolyte.

### PRIOR ART DOCUMENTS

### Patent Documents

Patent Document 1: JP-A-5-47381
Patent Document 2: JP-A-7-22017
Patent Document 3: JP-A-61-74258

### SUMMARY OF THE INVENTION

### Problems to be Solved by the Invention

In nonaqueous electrolyte energy storage devices, the use of fluorinated solvents such as fluorinated carbonates have been studied for purpose such as suppressing the oxidative decomposition of nonaqueous electrolytes, caused under high potentials. The inventors have found, however, that in the case of a nonaqueous electrolyte energy storage device in which a nonaqueous electrolyte containing a fluorinated solvent is used, short circuits may be inadequately suppressed even by simply using, as a negative active material, an alloy of a metal capable of dissolution in lithium as a solid solution and metal lithium as mentioned in Patent Document 1.

In nonaqueous electrolyte energy storage devices, typically, fluorine-containing lithium salts with favorable oxidation resistance, solubility, dissociability of lithium ions, and the like are often used as the electrolyte salt. The inventors have found, however, that in the case of a nonaqueous electrolyte energy storage device in which a nonaqueous electrolyte including a lithium salt containing fluorine is used, short circuits may be inadequately suppressed even by simply using, as a negative active material, an alloy of a metal capable of dissolution in lithium as a solid solution and metal lithium as mentioned in Patent Document 1.

The present invention has been made in view of the circumstances as described above.

An object of the present invention is to provide a nonaqueous electrolyte energy storage device including a nonaqueous electrolyte containing a fluorinated solvent, in which any short circuit is suppressed, and a method for manufacturing such a nonaqueous electrolyte energy storage device.

Another object of the present invention is to provide a nonaqueous electrolyte energy storage device including a nonaqueous electrolyte including a lithium salt containing fluorine, in which any short circuit is suppressed, and a method for manufacturing such a nonaqueous electrolyte energy storage device.

### Means for Solving the Problems

An aspect of the present invention is a nonaqueous electrolyte energy storage device that includes a negative electrode including a lithium alloy and a nonaqueous electrolyte containing a fluorinated solvent, in which the lithium alloy contains silver, and the content of silver with respect to the total content of lithium and silver in the lithium alloy is 3% by mass or more and 20% by mass or less.

Another aspect of the present invention is a nonaqueous electrolyte energy storage device that includes a negative electrode including a lithium alloy and a nonaqueous electrolyte including a lithium salt containing fluorine, in which the lithium alloy contains silver, and the content of silver with respect to the total content of lithium and silver in the lithium alloy is 3% by mass or more and 20% by mass or less.

Another aspect of the present invention is a method for manufacturing a nonaqueous electrolyte energy storage device, including: preparing a negative electrode including a lithium alloy; and preparing a nonaqueous electrolyte containing a fluorinated solvent, in which the lithium alloy contains silver, and the content of silver with respect to the total content of lithium and silver in the lithium alloy is 3% by mass or more and 20% by mass or less.

Another aspect of the present invention is a method for manufacturing a nonaqueous electrolyte energy storage device, including: preparing a negative electrode including a lithium alloy; and preparing a nonaqueous electrolyte including a lithium salt containing fluorine, in which the lithium alloy contains silver, and the content of silver with respect to the total content of lithium and silver in the lithium alloy is 3% by mass or more and 20% by mass or less.

### Advantages of the Invention

According to an aspect of the present invention, it is possible to provide a nonaqueous electrolyte energy storage device including a nonaqueous electrolyte containing a fluorinated solvent, in which any short circuit is suppressed, and a method for manufacturing such a nonaqueous electrolyte energy storage device.

According to another aspect of the present invention, it is possible to provide a nonaqueous electrolyte energy storage device including a nonaqueous electrolyte including a lithium salt containing fluorine, in which any short circuit is suppressed, and a method for manufacturing such a nonaqueous electrolyte energy storage device.

### BRIEF DESCRIPTION OF THE DRAWINGS

FIG. 1 is an external perspective view showing a nonaqueous electrolyte energy storage device according to one embodiment of the present invention.

FIG. 2 is a schematic view illustrating an energy storage apparatus configured by assembling a plurality of the nonaqueous electrolyte energy storage devices according to an embodiment of the present invention.

FIG. 3 is a graph showing the number of cycles until causing any short circuit in nonaqueous electrolyte energy storage devices according to examples and comparative examples.

FIG. 4 is a graph showing an amount of charge for each cycle in a charge-discharge cycle test for a nonaqueous electrolyte energy storage device according to Example 1.

FIG. 5 shows the charge-discharge curves of nonaqueous electrolyte energy storage devices according to Example 1 and Comparative Example 11 in the first cycle.

### MODE FOR CARRYING OUT THE INVENTION

First, outlines of a nonaqueous electrolyte energy storage device and a method for manufacturing the nonaqueous electrolyte energy storage device disclosed by the present specification will be described.

A nonaqueous electrolyte energy storage device according to an aspect of the present invention is a nonaqueous electrolyte energy storage device that includes a negative electrode including a lithium alloy and a nonaqueous electrolyte containing a fluorinated solvent, in which the lithium alloy contains silver, and the content of silver with respect to the total content of lithium and silver in the lithium alloy is 3% by mass or more and 20% by mass or less.

The nonaqueous electrolyte energy storage device suppresses, in spite of including the nonaqueous electrolyte containing the fluorinated solvent, a short circuit due to the growth of a dendrite. Although the reason for this is not clear, the following reason is presumed. The paragraphs [0008], [0020], and the like of Patent Document 1 describes that the solid solution of a metal in lithium changes the crystal structure of the lithium to cause many active sites for precipitation to be present, thereby densely precipitating lithium during charge, and then inhibiting any dendritic growth. Based on such a theory, the same effect is considered also produced without being affected by the type of the metal in the solid solution in lithium and the type of the nonaqueous solvent. In fact, no difference in the effect due to the metal species in the solid solution is found in any example of Patent Document 1. In contrast, one of other factors that affect the dendrite growth is the presence of a film containing LiF formed on the surface of the negative electrode. This film, which is derived from a fluorinated solvent or the like, acts for inhibiting the dendrite growth, but when a lithium alloy is used for the negative electrode, the film formed on the surface of the negative electrode is considered likely to be inhomogeneous in some cases, depending on the type of the lithium alloy. In such a case, metal lithium is likely to be precipitated on the inhomogeneous part of the film, and thus, depending on charge-discharge conditions or the like, the dendrite growth is presumed to be unlikely to be sufficiently inhibited. In contrast, when the lithium alloy for use in the negative electrode contains silver, and when the content of silver with respect to the total content of lithium and silver in the lithium alloy is 3% by mass or more and 20% by mass or less, possibly because no oxidative-reductive reaction of the silver is substantially developed during charge-discharge, a film derived from the fluorinated solvent or the like, formed on the surface of the negative electrode, is likely to have high homogeneity, and the dendrite growth is presumed to be sufficiently suppressed, thereby making any short circuit unlikely to be caused. In addition, the nonaqueous electrolyte energy storage device according to an aspect of the present invention has a sufficiently high energy density, because the content of silver with respect to the total content of lithium and silver in the lithium alloy is 20% by mass or less, with the high content of lithium. Furthermore, the nonaqueous electrolyte energy storage device, in which the dendrite growth is inhibited, thus allows sufficient discharge with a small decrease in charge-discharge efficiency.

A nonaqueous electrolyte energy storage device according to another aspect of the present invention is a nonaqueous electrolyte energy storage device that includes a negative electrode including a lithium alloy and a nonaqueous electrolyte including a lithium salt containing fluorine, in which the lithium alloy contains silver, and the content of silver with respect to the total content of lithium and silver in the lithium alloy is 3% by mass or more and 20% by mass or less.

The nonaqueous electrolyte energy storage device suppresses, in spite of including the nonaqueous electrolyte including the lithium salt containing fluorine, a short circuit due to the growth of a dendrite. Although the reason for this is not clear, the following reason is presumed. The paragraphs [0008], [0020], and the like of Patent Document 1 describes that the solid solution of a metal in lithium changes the crystal structure of the lithium to cause many active sites for precipitation to be present, thereby densely precipitating lithium during charge, and then inhibiting any dendritic growth. Based on such a theory, the same effect is considered also produced without being affected by the type of the metal in the solid solution in lithium and the type of the electrolyte salt. In fact, no difference in the effect due to the metal species in the solid solution is found in any example of Patent Document 1. In contrast, one of other factors that affect the dendrite growth is the presence of a film containing LiF formed on the surface of the negative electrode. This film, which is derived from a lithium salt containing fluorine, or the like, acts for inhibiting the dendrite growth, but when a lithium alloy is used for the negative electrode, the film formed on the surface of the negative electrode is considered likely to be inhomogeneous in some cases, depending on the type of the lithium alloy. In such a case, metal lithium is likely to be precipitated on the inhomogeneous part of the film, and thus, depending on charge-discharge conditions or the like, the dendrite growth is presumed to be unlikely to be sufficiently inhibited. In contrast, when the lithium alloy for use in the negative electrode contains silver, and when the content of silver in the lithium alloy is 3% by mass or more and 20% by mass or less, possibly because no oxidative-reductive reaction of the silver is substantially developed during charge-discharge, a film derived from the lithium salt containing fluorine, or the like, formed on the surface of the negative electrode, is likely to have high homogeneity, and the dendrite growth is presumed to be sufficiently suppressed, thereby making any short circuit unlikely to be caused. In addition, the nonaqueous electrolyte energy storage device according to an aspect of the present invention has a sufficiently high energy density, because the content of silver in the lithium alloy is 20% by mass or less, with the high content of lithium. Furthermore, the nonaqueous electrolyte energy storage device, in which the dendrite growth is inhibited, thus allows sufficient discharge with a small decrease in charge-discharge efficiency.

The composition ratio of atoms constituting the lithium alloy (negative active material) in the negative electrode refers to a composition ratio in the lithium alloy discharged by the following method. First, the nonaqueous electrolyte energy storage device is subjected to constant current charge with a current of 0.05 C until the voltage becomes an end-of-charge voltage under normal usage, so that the energy storage device is brought to a fully charged state. After a 30-minute pause, the nonaqueous electrolyte energy storage device is subjected to constant current discharge with a current of 0.05 C to the lower limit voltage during normal usage. The nonaqueous electrolyte energy storage device is disassembled, and the negative electrode is taken out. The lithium alloy is collected from the taken-out negative electrode.

It is to be noted the term “under normal usage” means use of the nonaqueous electrolyte energy storage device while employing charge conditions recommended or specified for the nonaqueous electrolyte energy storage device. For example, when a charger for the nonaqueous electrolyte energy storage device is prepared, the term refers to a case of using the nonaqueous electrolyte energy storage device by applying the charger.

In the nonaqueous electrolyte energy storage device according to one aspect of the present invention, the positive electrode potential at the end-of-charge voltage under normal usage is preferably 4.30 V vs. Li/Li⁺ or higher. When the positive electrode potential at the end-of-charge voltage under normal usage is 4.30 V vs. Li/Li⁺ or higher, the nonaqueous electrolyte tends to be easily oxidatively decomposed, and the need for the use of a fluorinated solvent and/or a lithium salt containing fluorine is increased, thus increasing the usefulness of the present invention. In addition, when the positive electrode potential at the end-of-charge voltage under normal usage is 4.30 V vs. Li/Li⁺ or higher, a nonaqueous electrolyte energy storage device with a high energy density can be provided in combination with the use of the lithium alloy as a negative active material.

The nonaqueous electrolyte energy storage device according to an aspect of the present invention includes a positive electrode including a lithium transition metal composite oxide, in which the lithium transition metal composite oxide preferably has an α-NaFeO₂-type crystal structure, contains nickel or manganese as a transition metal, and has a molar ratio (Li/Me) of lithium (Li) to the transition metal (Me) in excess of 1. Such a lithium transition metal composite oxide is a positive active material that is high in electric capacity, and a nonaqueous electrolyte energy storage device including a positive electrode including the oxide is often used at a high current density. Typically, when the current density is high under normal usage of the nonaqueous electrolyte energy storage device, dendrites are likely to grow. Accordingly, in the case of the nonaqueous electrolyte energy storage device including the positive electrode including the lithium transition metal composite oxide mentioned above, the effect of suppressing any short circuit can be more remarkably enjoyed.

It is to be noted that the composition ratio of atoms constituting the positive active material refers to a composition ratio in a positive active material subjected to no charge-discharge, or a positive active material completely discharged by the following method. First, the nonaqueous electrolyte energy storage device is subjected to constant current charge with a current of 0.05 C until the voltage becomes an end-of-charge voltage under normal usage, so that the energy storage device is brought to a fully charged state. After a 30-minute pause, the nonaqueous electrolyte energy storage device is subjected to constant current discharge with a current of 0.05 C to the lower limit voltage during normal usage. After the nonaqueous electrolyte energy storage device is disassembled to take out the positive electrode, a test battery using a metal lithium electrode as the counter electrode is assembled, constant current discharge is performed at a current value of 10 mA per 1 g of a positive composite until the positive potential reaches 2.0 V (vs. Li/Li⁺), and the positive electrode is adjusted to the completely discharged state. The test battery is disassembled, and the positive electrode is taken out. An oxide of the positive active material is collected from the taken-out positive electrode.

The lithium alloy mentioned above is preferably composed substantially of lithium and silver. Any element other than silver is substantially not contained with respect to metal lithium, thereby allowing discharge at a low negative electrode potential that is equivalent to that for metal lithium, and then allowing a high energy density to be achieved. In addition, when the lithium alloy is composed substantially of lithium and silver, the content ratio of lithium can be increased, and the electric capacity can be increased.

A method for manufacturing a nonaqueous electrolyte energy storage device according to an aspect of the present invention is a method for manufacturing a nonaqueous electrolyte energy storage device, including: preparing a negative electrode including a lithium alloy; and preparing a nonaqueous electrolyte containing a fluorinated solvent, in which the lithium alloy contains silver, and the content of silver with respect to the total content of lithium and silver in the lithium alloy is 3% by mass or more and 20% by mass or less.

The manufacturing method is capable of manufacturing a nonaqueous electrolyte energy storage device including a nonaqueous electrolyte containing a fluorinated solvent, in which a short circuit is suppressed.

A method for manufacturing a nonaqueous electrolyte energy storage device according to another aspect of the present invention is a method for manufacturing a nonaqueous electrolyte energy storage device, including; preparing a negative electrode including a lithium alloy; and preparing a nonaqueous electrolyte including a lithium salt containing fluorine, in which the lithium alloy contains silver, and the content of silver with respect to the total content of lithium and silver in the lithium alloy is 3% by mass or more and 20% by mass or less.

The manufacturing method is capable of manufacturing a nonaqueous electrolyte energy storage device including a nonaqueous electrolyte including a lithium salt containing fluorine, in which a short circuit is suppressed.

Hereinafter, the nonaqueous electrolyte energy storage device according to an embodiment of the present invention and the method for manufacturing the nonaqueous electrolyte energy storage device will be described in order.

<Nonaqueous Electrolyte Energy Storage Device>

The nonaqueous electrolyte energy storage device according to an embodiment of the present invention has a positive electrode, a negative electrode, and a nonaqueous electrolyte. Hereinafter, a nonaqueous electrolyte secondary battery (hereinafter, also simply referred to as a “secondary battery”) will be described as an example of the nonaqueous electrolyte energy storage device. The positive electrode and the negative electrode usually form an electrode assembly in which the positive electrode and the negative electrode are alternately superposed by being stacked or wound with a separator interposed therebetween. The electrode assembly is housed in a case, and the case is filled with the nonaqueous electrolyte. The nonaqueous electrolyte is interposed between the positive electrode and the negative electrode. As the case, a known metal case, a resin case or the like, which is usually used as a case of a secondary battery, can be used.

(Positive Electrode)

The positive electrode has a positive substrate and a positive active material layer disposed directly or via an intermediate layer on the positive substrate.

The positive substrate has conductivity. Having “conductivity” means having a volume resistivity of 10⁷ Ω·cm or less that is measured in accordance with JIS-H-0505 (1975), and the term “non-conductivity” means that the volume resistivity is more than 10⁷ Ω·cm. As the material of the positive substrate, a metal such as aluminum, titanium, tantalum, stainless steel, or an alloy thereof is used. Among these, aluminum and aluminum alloys are preferable from the viewpoint of the balance of electric potential resistance, high conductivity, and cost. Example of the form of formation of the positive substrate include a foil and a vapor deposition film, and a foil is preferred from the viewpoint of cost. In other words, an aluminum foil is preferable as the positive substrate. Examples of the aluminum or aluminum alloy include A1085 and A3003 prescribed in JIS-H-4000 (2014).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. When the average thickness of the positive substrate is within the above-described range, it is possible to enhance the energy density per volume of a secondary battery while increasing the strength of the positive substrate. The “average thickness” refers to a value obtained by dividing the cutout mass in cutout of a substrate having a predetermined area by the true density and cutout area of the substrate. Hereinafter, the same applies to the “average thickness”.

The intermediate layer is a coating layer on the surface of the positive substrate, and contains conductive particles such as carbon particles to reduce contact resistance between the positive substrate and the positive active material layer. The configuration of the intermediate layer is not particularly limited but can be formed of, for example, a composition containing a resin binder and conductive particles.

The positive active material layer is formed of a so-called positive composite containing a positive active material. The positive composite forming the positive active material layer may contain optional components such as a conductive agent, a binder, a thickener, and a filler and the like as necessary.

The positive active material can be appropriately selected from known positive active materials. As the positive active material for a lithium secondary battery, a material capable of storing and releasing lithium ions is usually used. Examples of the positive active material include lithium transition metal composite oxides having an α-NaFeO₂-type crystal structure, lithium transition metal oxides having a spinel-type crystal structure, polyanion compounds, chalcogenides, and sulfur. Examples of the lithium transition metal composite oxide having an α-NaFeO₂-type crystal structure include Li[LiₓNi₁₋ₓ]O₂ (0≤x<0.5), Li[LiₓNi_{γ}Co_{1-x-γ}]O₂ (0≤x<0.5, 0<γ<1), Li[LiₓCo₁₋ₓ]O₂ (0≤x<0.5), Li[LiₓNi_{γ}Mn_{1-x-γ}]O₂ (0≤x<0.5, 0≤γ<1), Li[LiₓNi_{γ}Mn_{ß}Co_{1-x-γ-ß}]O₂ (0≤x<0.5, 0<γ, 0<ß, 0.5<γ+ß<1), and Li[LiₓNi_{γ}Co_{ß}Al_{1-x-γ-ß}]O₂ (0≤x<0.5, 0<γ, 0<ß, 0.5<γ+ß<1). Examples of the lithium transition metal oxide having a spinel-type crystal structure include LiₓMn₂O₄ and LiₓNi_{γ}Mn_{2-γ}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. A part of atoms or polyanions in these materials may be substituted with atoms or anion species composed of other elements. The surfaces of these materials may be coated with other materials. In the positive active material layer, one of these materials may be used singly, or two or more thereof may be used in mixture.

As the positive active material, a lithium transition metal composite oxide is preferable, and a lithium transition metal composite oxide that has an α-NaFeO₂-type crystal structure is more preferable. The lithium transition metal composite oxide preferably contains nickel or manganese as a transition metal, and more preferably contains both nickel and manganese. The lithium transition metal composite oxide may further contain another transition metal such as cobalt. In the lithium transition metal composite oxide that has an α-NaFeO₂-type crystal structure, the molar ratio (Li/Me) of lithium (Li) to the transition metal (Me) is preferably more than 1, more preferably 1.1 or more, still more preferably 1.2 or more. The use of such a lithium transition metal composite oxide allows an increase in electric capacity. In addition, in the case of a nonaqueous electrolyte energy storage device with such a positive active material used, the device tends to be used at a high current density, and typically, dendrites are likely to grow. Accordingly, in the case of the nonaqueous electrolyte energy storage device including the positive electrode including the lithium transition metal composite oxide mentioned above, the effect of suppressing any short circuit can be more remarkably enjoyed. It is to be noted that the upper limit of the molar ratio (Li/Me) of lithium to the transition metal is preferably 1.6, more preferably 1.5.

As the lithium transition metal composite oxide that has an α-NaFeO₂-type crystal structure, a compound represented by the following formula (1) is preferable.

Li_{1+α}Me_{1-α}O₂ (1)

In the formula (1), Me is a transition metal containing Ni or Mn. The condition of 0<α<1 is met.

Me in the formula (1) preferably contains Ni and Mn. Me is preferably composed substantially of two elements of Ni and Mn or three elements of Ni, Mn, and Co. Me may contain other transition metals.

In the formula (1), the lower limit of the molar ratio (Ni/Me) of Ni to Me is preferably 0.1, more preferably 0.2. In contrast, the upper limit of this molar ratio (Ni/Me) is preferably 0.5, more preferably 0.45. The molar ratio (Ni/Me) within the above-mentioned range improves the energy density.

In the formula (1), the lower limit of the molar ratio (Mn/Me) of Mn to Me is preferably 0.5, more preferably 0.55. In contrast, the upper limit of this molar ratio (Mn/Me) is preferably 0.75, more preferably 0.7. The molar ratio (Mn/Me) within the above-mentioned range improves the energy density.

In the formula (1), the upper limit of the molar ratio (Co/Me) of Co to Me is preferably 0.3, more preferably 0.2. The molar ratio (Co/Me) or the lower limit of the molar ratio (Co/Me) may be 0.

In the formula (1), the molar ratio (Li/Me) of Li to Me, that is, (1+α)/(1−α) is preferably more than 1.0 (α>0), more preferably 1.1 or more, still more preferably 1.2 or more. In contrast, the upper limit of this molar ratio (Li/Me) is preferably 1.6, more preferably 1.5. The molar ratio (Li/Me) within the range mentioned above increases the discharge capacity.

The lower limit of the content of the lithium transition metal composite oxide with respect to the total positive active material is preferably 50% by mass, more preferably 80% by mass, still more preferably 95% by mass. The content of the lithium transition metal composite oxide with respect to the total positive active material may be 100% by mass.

The average particle size of the positive active material is preferably 0.1 μm or more and 20 μm or less, for example. By setting the average particle size of the positive active material to be equal to or greater than the above lower limit, the positive active material is easily manufactured or handled. By setting the average particle size of the positive active material to be equal to or less than the above upper limit, the electron conductivity of the positive active material layer is improved. Here, the term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher, a classifier, or the like is used to obtain particles of the positive active material in a predetermined shape. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner. The content of the positive active material in the positive active material layer is preferably 70% by mass or more and 98% by mass or less, more preferably 80% by mass or more and 97% by mass or less, further preferably 90% by mass or more and 96% by mass or less. The content of the positive active material particles within the range mentioned above allows an increase in the electric capacity of the secondary battery.

The conductive agent is not particularly limited so long as it is a material having conductivity. Examples of such a conductive agent include carbonaceous materials; metals; and conductive ceramics. Examples of carbonaceous materials include graphite and carbon black. Examples of the type of the carbon black include furnace black, acetylene black, and ketjen black. Among these, carbonaceous materials are preferable from the viewpoint of conductivity and coatability. In particular, acetylene black and ketjen black are preferable. Examples of the shape of the conductive agent include a powder shape, a sheet shape, and a fibrous shape.

The content of the conductive agent in the positive active material layer is preferably 1% by mass or more and 40% by mass or less, more preferably 2% by mass or more and 10% by mass or less. By setting the content of the conductive agent in the above range, the energy density of the secondary battery can be enhanced.

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers.

The content of the binder in the positive active material layer is preferably 0.5% by mass or more and 10% by mass or less, more preferably 1% by mass or more and 6% by mass or less. When the content of the binder is in the above range, the active material can be stably held.

Examples of the thickener include polysaccharide polymers such as carboxymethylcellulose (CMC) and methylcellulose. When the thickener has a functional group that reacts with lithium, it is preferable to deactivate this functional group by methylation and the like in advance. According to an aspect of the present invention, the thickener is preferably not contained in the positive active material layer in some cases.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof. According to an aspect of the present invention, the filler is preferably not contained in the positive active material layer in some cases.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

(Negative Electrode)

The negative electrode has a negative substrate and a negative active material layer disposed directly or via an intermediate layer on the negative substrate. The intermediate layer of the negative electrode may have the same configuration as the intermediate layer of the positive electrode.

Although the negative substrate may have the same configuration as that of the positive substrate, as the material, metals such as copper, nickel, stainless steel, and nickel-plated steel or alloys thereof are used, and copper or a copper alloy is preferable. That is, the negative substrate is preferably a copper foil. Examples of the copper foil include rolled copper foil, electrolytic copper foil, and the like.

The average thickness of the negative substrate is preferably 2 μm or more and 35 μm or less, more preferably 3 μm or more and 30 μm or less, still more preferably 4 μm or more and 25 μm or less, particularly preferably 5 μm or more and 20 μm or less. When the average thickness of the negative substrate is within the above-described range, it is possible to enhance the energy density per volume of a secondary battery while increasing the strength of the negative substrate.

The negative active material layer has a lithium alloy. The lithium alloy is a component that functions as a negative active material.

The lithium alloy contains silver. The lower limit of the content of silver with respect to the total content of lithium and silver in the lithium alloy is 3% by mass, preferably 5% by mass, more preferably 7% by mass. The content of silver with respect to the total content of lithium and silver in the lithium alloy is set to be equal to or more than the above lower limit, thereby further suppressing the dendrite growth, and further suppressing short circuits. In contrast, the upper limit of the content of silver with respect to the total content of lithium and silver in the lithium alloy is 20% by mass, preferably 15% by mass, more preferably 10% by mass. The content of silver with respect to the total content of lithium and silver in the lithium alloy is set to be less than or equal to the above upper limit, thereby allowing effects such as an increase in energy density.

The lithium alloy may contain components other than lithium and silver, but is preferably composed substantially of lithium and silver. It is to be noted that the phrase “the lithium alloy is composed substantially of lithium and silver” means that the lithium alloy contains substantially no components other than lithium and silver, and the content of components other than lithium and silver is preferably less than 1% by mass, more preferably less than 0.1% by mass, still more preferably less than 0.01 by mass. The content of components other than lithium and silver within the range mentioned above allows discharge at a low negative electrode potential that is equivalent to that for metal lithium, and then allows a high energy density to be achieved. In addition, the content of components other than lithium and silver within the range mentioned above allows, as a result, the content of lithium to be increased, and then allows the electric capacity to be increased.

The negative active material layer may be a layer composed substantially of only a lithium alloy. For example, the content of the lithium alloy in the negative active material layer may be 99% by mass or more, and may be 100% by mass. In addition, the composition ratio between lithium and silver may be non-uniform for each part of the negative active material layer formed from the lithium alloy. For example, the negative active material layer may be formed of multiple layers that differ in composition ratio between lithium and silver, and in this case, may include a layer that does not contain one of lithium and silver. The negative active material layer may be a single layer formed from a lithium alloy that has a substantially uniform composition ratio between lithium and silver.

The negative active material layer may be a lithium alloy foil. The average thickness of the negative active material layer is preferably 5 μm or more and 1,000 μm or less, more preferably 10 μm or more and 500 μm or less, still more preferably 30 μm or more and 300 μm or less.

(Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles included in the heat resistant layer preferably have a mass loss of 5% or less in the case of heating from room temperature to 500° C. under the atmosphere, and more preferably have a mass loss of 5% or less in the case of heating from room temperature to 800° C. under the atmosphere. Inorganic compounds can be mentioned as materials whose mass loss is less than or equal to a predetermined value when the materials are heated. Examples of the inorganic compound include oxides such as iron oxide, silicon oxide, aluminum oxide, titanium dioxide, barium titanate, zirconium oxide, calcium oxide, strontium oxide, barium oxide, magnesium oxide and aluminosilicate; hydroxides such as magnesium hydroxide, calcium hydroxide and aluminum hydroxide; nitrides such as aluminum nitride and silicon nitride; carbonates such as calcium carbonate; sulfates such as barium sulfate; hardly soluble ionic crystals of calcium fluoride, barium fluoride, and the like; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used singly, or two or more thereof may be used in mixture. Among these inorganic compounds, silicon oxide, aluminum oxide, or aluminosilicate is preferable from the viewpoint of safety of the energy storage device.

A porosity of the separator is preferably 80% by volume or less from the viewpoint of strength, and is preferably 20% by volume or more from the viewpoint of discharge performance. Here, the “porosity” is a volume-based value, and means a value measured with a mercury porosimeter.

As the separator, a polymer gel composed of a polymer and a nonaqueous electrolyte may be used. Examples of the polymer include polyacrylonitrile, polyethylene oxide, polypropylene oxide, polymethyl methacrylate, polyvinyl acetate, polyvinylpyrrolidone, and polyvinylidene fluoride. The use of polymer gel has the effect of suppressing liquid leakage. As the separator, a polymer gel may be used in combination with a porous resin film, a nonwoven fabric, or the like as described above.

(Nonaqueous Electrolyte)

The nonaqueous electrolyte includes a fluorinated solvent and/or a lithium salt containing fluorine as an electrolyte salt. The nonaqueous electrolyte may be a nonaqueous electrolyte solution that includes: a nonaqueous solvent including a fluorinated solvent; and an electrolyte salt dissolved in the nonaqueous solvent. The nonaqueous electrolyte may be a nonaqueous electrolyte solution that includes: a nonaqueous solvent; and an electrolyte salt including a lithium salt containing fluorine, dissolved in the nonaqueous solvent.

The fluorinated solvent is a solvent that has a fluorine atom. The fluorinated solvent may be a solvent in which some or all of hydrogen atoms in a hydrocarbon group in a nonaqueous solvent having the hydrocarbon group are substituted with fluorine atoms. The use of the fluorinated solvent allows a film containing LiF, capable of suppressing the dendrite growth, to be formed on the surface of the negative electrode. In addition, the use of the fluorinated solvent enhances the oxidation resistance, and allows favorable charge-discharge cycle performance to be maintained even in the case of charge in which the positive electrode potential during normal usage reaches a high potential. Examples of the fluorinated solvent include fluorinated carbonates, fluorinated carboxylic acid esters, fluorinated phosphoric acid esters, and fluorinated ethers. One of the fluorinated solvents, or two or more thereof can be used.

Among fluorinated solvents, fluorinated carbonates are preferable, and fluorinated cyclic carbonates and fluorinated chain carbonates are more preferably used in combination. The use of the cyclic carbonate allows the dissociation of the electrolyte salt to be promoted to improve the ionic conductivity of the nonaqueous electrolyte. The uses of the fluorinated chain carbonate allows the viscosity of the nonaqueous electrolyte to be kept low. When the fluorinated cyclic carbonate and the fluorinated chain carbonate are used in combination, the volume ratio of the fluorinated cyclic carbonate to the fluorinated chain carbonate (fluorinated cyclic carbonate fluorinated chain carbonate) is preferably in a range from 5:95 to 50:50, for example.

The lower limit of the content ratio of the fluorinated carbonate in the fluorinated solvent is preferably 50% by volume, more preferably 70% by volume, still more preferably 90% by volume. The upper limit of the content ratio of the fluorinated carbonate in the fluorinated solvent may be 100% by volume.

Examples of the fluorinated cyclic carbonate include fluorinated ethylene carbonates such as fluoroethylene carbonate (FEC) and difluoroethylene carbonate, fluorinated propylene carbonates, and fluorinated butylene carbonates. Among these carbonates, fluorinated ethylene carbonates are preferable, and FEC is more preferable. The FEC exhibits high oxidation resistance and has a high effect of suppressing side reactions (oxidative decomposition of nonaqueous solvent and the like) that may occur at the time of charge-discharge of the secondary battery.

Examples of the fluorinated chain carbonate include 2,2,2-trifluoroethyl methyl carbonate and bis(2,2,2-trifluoroethyl)carbonate.

Examples of the fluorinated carboxylic acid ester include methyl 3,3,3-trifluoropropionate and 2,2,2-trifluoroethyl acetate.

Examples of the fluorinated phosphoric acid ester include tris(2,2-difluoroethyl) phosphate and tris(2,2,2-trifluoroethyl) phosphate.

Examples of the fluorinated ether include 1,1,2,2-tetrafluoroethyl-2,2,2-trifluoroethyl ether, methylheptafluoropropyl ether, and methylnonafluorobutyl ether.

The nonaqueous solvent may contain a nonaqueous solvent other than the fluorinated solvent. Examples of such a nonaqueous solvent include carbonates other than the fluorinated solvent, carboxylic acid esters, phosphoric acid esters, ethers, amides, and nitriles.

The lower limit of the content ratio of the fluorinated solvent to the total nonaqueous solvent is preferably 50% by volume, more preferably 70% by volume, still more preferably 90% by volume, still more preferably 99% by volume. The content ratio of the fluorinated solvent to the total nonaqueous solvent is particularly preferably 100% by volume. The nonaqueous solvent is composed substantially of only the fluorinated solvent, thereby allowing the oxidation resistance to be further improved.

Examples of the lithium salt containing fluorine include inorganic lithium salts containing fluorine, such as LiPF₆, LiPO₂F₂, LiBF₄, and LiN(SO₂F)₂, and lithium salts having a fluorinated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these salts, an inorganic lithium salt containing fluorine is preferable, and LiPF₆ is more preferable.

The content of the electrolyte salt containing fluorine in the nonaqueous electrolyte is preferably 0.1 mol/dm³ or more and 2.5 mol/dm³ or less, more preferably 0.3 mol/dm³ or more and 2.0 mol/dm³ or less, further preferably 0.5 mol/dm³ or more and 1.7 mol/dm³ or less, and particularly preferably 0.7 mol/dm³ or more and 1.5 mol/dm³ or less. The content of the lithium salt containing fluorine within the range mentioned above allows the ionic conductivity of the nonaqueous electrolyte to be increased.

As the electrolyte salt, other electrolyte salts may be used in combination with the lithium salt containing fluorine. The content of the lithium salt containing fluorine with respect to the total electrolyte salt is, however, preferably 90 mol % or more, preferably 99 mol % or more, more preferably substantially 100 mol %.

In the case of using other electrolyte salts in combination with the lithium salt containing fluorine, the content of the total electrolyte salt in the nonaqueous electrolyte is preferably 0.1 mol/dm³ or more and 2.5 mol/dm³ or less, more preferably 0.3 mol/dm³ or more and 2.0 mol/dm³ or less, further preferably 0.5 mol/dm³ or more and 1.7 mol/dm³ or less, and particularly preferably 0.7 mol/dm³ or more and 1.5 mol/dm³ or less. The content of the total electrolyte salt within the range mentioned above allows the ionic conductivity of the nonaqueous electrolyte to be increased.

The nonaqueous electrolyte may contain an additive. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethylsulfoxide, diethyl sulfoxide, tetramethylene sulfoxide, diphenyl sulfide, 4,4′-bis(2,2-dioxo-1,3,2-dioxathiolane), 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. One of these additives may be used singly, or two or more thereof may be used in mixture.

The content of the additive contained in the nonaqueous electrolyte is preferably 0.01% by mass or more and 10% by mass or less, more preferably 0.1% by mass or more and 7% by mass or less, further preferably 0.2% by mass or more and 5% by mass or less, and particularly preferably 0.3% by mass or more and 3% by mass or less, with respect to the total nonaqueous electrolyte. When the content of the additive is within the above range, it is possible to improve capacity retention performance or charge-discharge cycle performance after high-temperature storage, and to further improve safety.

In the secondary battery (nonaqueous electrolyte energy storage device), the positive electrode potential at the end-of-charge voltage under normal usage is preferably 4.30 V vs. Li/Li⁺ or more, more preferably 4.35 V vs. Li/Li⁺ or more, and further preferably less than 4.40 V vs. Li/Li⁺ or more in some cases. The positive electrode potential at the end-of-charge voltage under normal usage is set to be equal to or more than the above lower limit, thereby allowing the discharge capacity to be increased, and allowing the energy density to be increased.

The upper limit of the positive electrode potential at the end-of-charge voltage under normal usage of the secondary battery is, for example, 5.0 V vs. Li/Li+, and may be 4.8 V vs. Li/Li⁺ or may be 4.7 V vs. Li/Li+.

Dendrites have a tendency to grow when the current density during charge is high. Accordingly, the nonaqueous electrolyte energy storage device according to one embodiment of the present invention can be suitably applied to an application in which charge with a high current density is performed. Examples of such an application include a power source for an automobile such as an electric vehicle (EV), a hybrid electric vehicle (HEV), or a plug-in hybrid electric vehicle (PHEV), and a power source for charge with regenerative electric power.

The shape of the nonaqueous electrolyte energy storage device according to the present embodiment is not particularly limited, and examples thereof include cylindrical batteries, pouched batteries, prismatic batteries, flat batteries, coin batteries and button batteries.

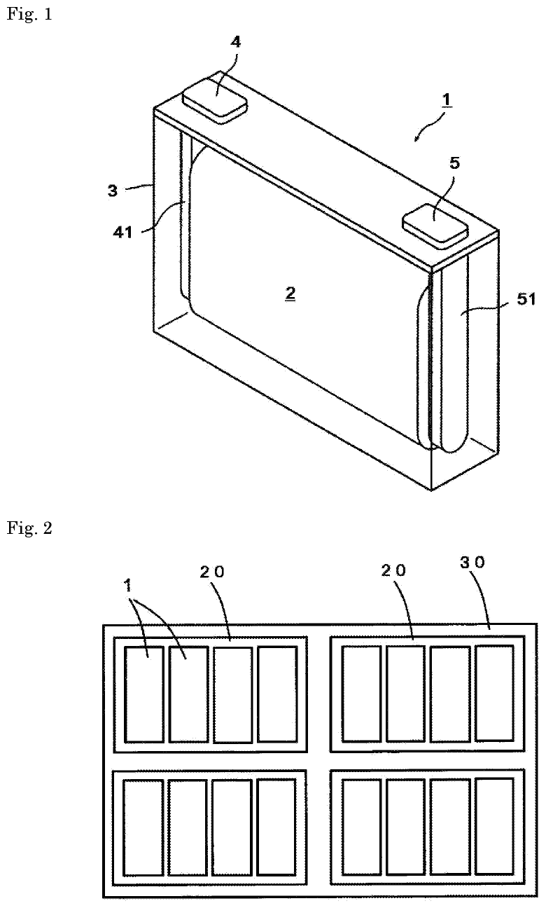

FIG. 1 shows a nonaqueous electrolyte energy storage device 1 as an example of a prismatic battery. FIG. 1 is a view showing an inside of a case in a perspective manner. An electrode assembly 2 having a positive electrode and a negative electrode which are wound with a separator interposed therebetween is housed in a prismatic case 3. The positive electrode is electrically connected to a positive electrode terminal 4 through a positive electrode lead 41. The negative electrode is electrically connected to a negative electrode terminal 5 via a negative electrode lead 51.

<Configuration of Nonaqueous Electrolyte Energy Storage Apparatus>

The nonaqueous electrolyte energy storage device according to the present embodiment can be mounted as an energy storage unit (battery module) configured by assembling a plurality of nonaqueous electrolyte energy storage devices 1 on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique according to one embodiment of the present invention may be applied to at least one nonaqueous electrolyte energy storage device included in the energy storage unit.

FIG. 2 shows an example of an energy storage apparatus 30 formed by assembling energy storage units 20 in each of which two or more electrically connected nonaqueous electrolyte energy storage devices 1 are assembled. The energy storage apparatus 30 may include a busbar (not illustrated) for electrically connecting two or more nonaqueous electrolyte energy storage devices 1 and a busbar (not illustrated) for electrically connecting two or more energy storage units 20. The energy storage unit 20 or the energy storage apparatus 30 may include a state monitor (not illustrated) that monitors the state of one or more nonaqueous electrolyte energy storage devices.

<Method for Manufacturing Nonaqueous Electrolyte Energy Storage Device>

A method for manufacturing the nonaqueous electrolyte energy storage device according to an embodiment of the present invention includes: preparing a negative electrode including a lithium alloy; and preparing a nonaqueous electrolyte containing a fluorinated solvent, the lithium alloy contains silver, and the content of silver with respect to the total content of lithium and silver in the lithium alloy is 3% by mass or more and 20% by mass or less.

A method for manufacturing the nonaqueous electrolyte energy storage device according to another embodiment of the present invention includes: preparing a negative electrode including a lithium alloy; and preparing a nonaqueous electrolyte including a lithium salt containing fluorine, the lithium alloy contains silver, and the content of silver with respect to the total content of lithium and silver in the lithium alloy is 3% by mass or more and 20% by mass or less.

Preparing the negative electrode including the lithium alloy may be fabricating the negative electrode including the lithium alloy. The negative electrode can be fabricated by laminating a negative active material layer containing a lithium alloy directly on a negative substrate or over the substrate with an intermediate layer interposed therebetween, and pressing or the like. The negative active material layer containing a lithium alloy may be a lithium alloy foil. The specific form and suitable form of the negative electrode to be prepared are the same as the specific form and suitable form of the negative electrode provided in the nonaqueous electrolyte energy storage device according to an embodiment of the present invention.

Preparing the nonaqueous electrolyte containing the fluorinated solvent may be preparing a nonaqueous electrolyte containing a fluorinated solvent. The nonaqueous electrolyte can be prepared by mixing respective components constituting the nonaqueous electrolyte, such as a fluorinated solvent and other components. The specific form and suitable form of the nonaqueous electrolyte to be prepared are the same as the specific form and suitable form of the nonaqueous electrolyte provided in the nonaqueous electrolyte energy storage device according to an embodiment of the present invention.

Preparing the nonaqueous electrolyte including the lithium salt containing fluorine may be preparing a nonaqueous electrolyte including the lithium salt containing fluorine. The nonaqueous electrolyte can be prepared by mixing respective components constituting the nonaqueous electrolyte, such as a lithium salt containing fluorine and a nonaqueous solvent. The specific form and suitable form of the nonaqueous electrolyte to be prepared are the same as the specific form and suitable form of the nonaqueous electrolyte provided in the nonaqueous electrolyte energy storage device according to an embodiment of the present invention.

The method for manufacturing the nonaqueous electrolyte energy storage device includes, for example, preparing or fabricating the positive electrode, preparing or fabricating a negative electrode, preparing or fabricating a nonaqueous electrolyte, forming an electrode assembly in which the positive electrode and the negative electrode are alternately superposed by stacking or winding the positive electrode and the negative electrode with a separator interposed between the electrodes, housing the positive electrode and the negative electrode (electrode assembly) in a case, and injecting the nonaqueous electrolyte into the case. The nonaqueous electrolyte energy storage device can be obtained by sealing an injection port after the injection.

In addition, the nonaqueous electrolyte energy storage device according to one embodiment of the present invention can also be manufactured by irreversibly supplying lithium from the positive electrode at the time of initial charge to adjust the content of silver to be 3% by mass or more and 20% by mass or less with respect to the total content of lithium and silver in the lithium alloy of the negative electrode.

### OTHER EMBODIMENTS

The present invention is not limited to the above embodiments, and various modifications may be made without departing from the gist of the present invention. For example, a configuration according to one embodiment can additionally be provided with a configuration according to another embodiment, or a configuration according to one embodiment can partially be replaced with a configuration according to another embodiment or a well-known technique. Furthermore, a part of the configuration according to one embodiment can be removed. In addition, a well-known technique can be added to the configuration according to one embodiment.

In the above embodiment, although the case where the energy storage device is used as a nonaqueous electrolyte secondary battery (for example, lithium secondary battery) that can be charged and discharged has been described, the type, shape, size, capacity, and the like of the energy storage device are arbitrary. The nonaqueous electrolyte energy storage device according to the present invention can also be applied to capacitors such as various nonaqueous electrolyte secondary batteries, electric double layer capacitors, and lithium ion capacitors.

### EXAMPLES

Hereinafter, the present invention will be described in more detail with reference to Examples, but the present invention is not limited to the following Examples.

### Example 1

(Fabrication of Positive Electrode)

As a positive active material, a lithium-transition metal composite oxide, which had an α-NaFeO₂-type crystal structure and was represented by Li_{1+α}Me_{1-α}O₂ (Me was a transition metal), was used. In this regard, the molar ratio Li/Me of Li to Me was 1.33, and Me was composed of Ni and Mn and was contained at a molar ratio of Ni:Mn=1:2.

A positive electrode paste, which contained the positive active material, acetylene black (AB) as a conductive agent, and polyvinylidene fluoride (PVDF) as a binder at a mass ratio of 94:4.5:1.5, was prepared using N-methylpyrrolidone (NMP) as a dispersion medium. The positive electrode paste was applied to one surface of an aluminum foil with an average thickness of 15 μm as a positive substrate, and dried, and the resultant was pressed and cut to fabricate a positive electrode having a positive active material layer disposed in a rectangular shape having a width of 30 mm and a length of 40 mm.

(Fabrication of Negative Electrode)

On one surface of a copper foil of 10 μm in average thickness as a negative substrate, a lithium-silver alloy foil (with a silver content of 10% by mass with respect to the total content of lithium and silver) of 100 μm in average thickness as a negative active material was laminated as a negative active material layer, and pressed and then cut to fabricate a negative electrode with a negative active material layer disposed in a rectangular shape of 32 mm in width and 42 mm in length.

(Preparation of Nonaqueous Electrolyte)

As a nonaqueous electrolyte, LiPF₆ was dissolved at a concentration of 1 mol/dm³ in a mixed solvent of fluoroethylene carbonate (FEC) and 2,2,2-trifluoroethylmethyl carbonate (TFEMC) mixed at a volume ratio of FEC TFEMC=30:70.

(Fabrication of Nonaqueous Electrolyte Energy Storage Device)

The positive electrode and the negative electrode were stacked with the separator interposed therebetween, thereby fabricating an electrode assembly. The electrode assembly was housed in a case, then the nonaqueous electrolyte was injected into the inside of the case, and then an opening of the case was sealed by heat sealing to obtain a nonaqueous electrolyte energy storage device (secondary battery) according to Example 1 as a pouched cell. It is to be noted that the nonaqueous electrolyte energy storage device was subjected to pressing with a jig. The fixing screw of the jig was tightened with a tightening torque of 15 cNm such that the pressure applied to the nonaqueous electrolyte energy storage device was about 0.3 MPa.

### Example 2 and Comparative Examples 1 to 11

Nonaqueous electrolyte energy storage devices according to Example 2 and Comparative Examples 1 to 11 were obtained similarly to Example 1 except that the type (composition) of the negative active material was employed as presented in Table 1.

It is to be noted that in the nonaqueous electrolyte energy storage devices according to each example and each comparative example, the composition ratio (the content of silver with respect to the total content of lithium and silver) of the lithium alloy used for the fabrication of the negative electrode, subjected to no charge-discharge, is substantially the same as the composition ratio of the lithium alloy in a discharged state.

(Initial Charge-Discharge)

The obtained respective nonaqueous electrolyte energy storage devices were subjected to the initial charge-discharge under the following conditions. At 25° C., constant current constant voltage charge was performed at a charge current of 0.1 C and an end-of-charge voltage of 4.60 V. With regard to the charge termination conditions, charge was performed until the charge current reached 0.02 C. Thereafter, a pause time of 10 minutes was provided. Thereafter, constant current discharge was performed at a discharge current of 0.1 C and an end-of-discharge voltage of 2.00 V, and then a pause time of 10 minutes was provided. This charge-discharge cycle was performed for 2 cycles.

(Charge-Discharge Cycle Test)

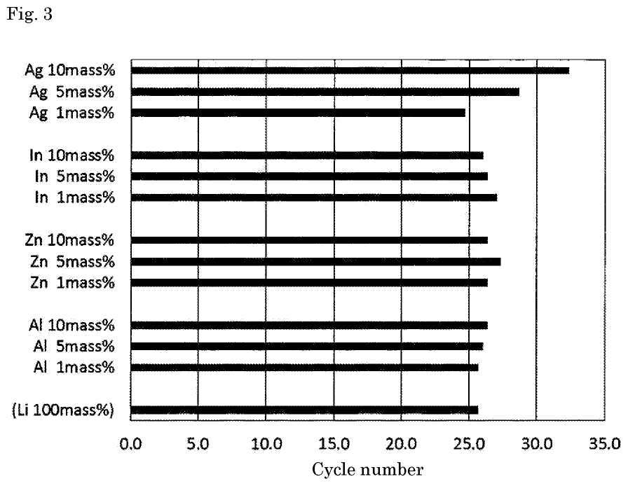

Subsequently, the following charge-discharge cycle test was performed. At 25° C., constant current constant voltage charge was performed at a charge current of 0.2 C and an end-of-charge voltage of 4.60 V. With regard to the charge termination conditions, charge was performed until the charge current reached 0.05 C. Thereafter, a pause time of 10 minutes was provided. Thereafter, constant current discharge was performed at a discharge current of 0.1 C and an end-of-discharge voltage of 2.00 V, and then a pause time of 10 minutes was provided. This charge-discharge cycle was repeated, and the number of cycles was recorded until causing a short circuit. The results are shown in Table 1 and FIG. 3. For each example and each comparative example, nonaqueous electrolyte energy storage devices were prepared for three samples, and subjected to the charge-discharge cycle test. The number of cycles until causing a short circuit, shown in Table 1 and FIG. 3, was considered as an average value for the three samples.

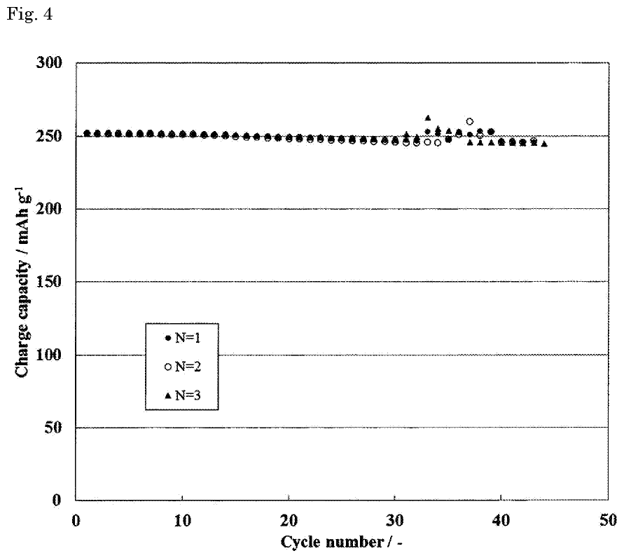

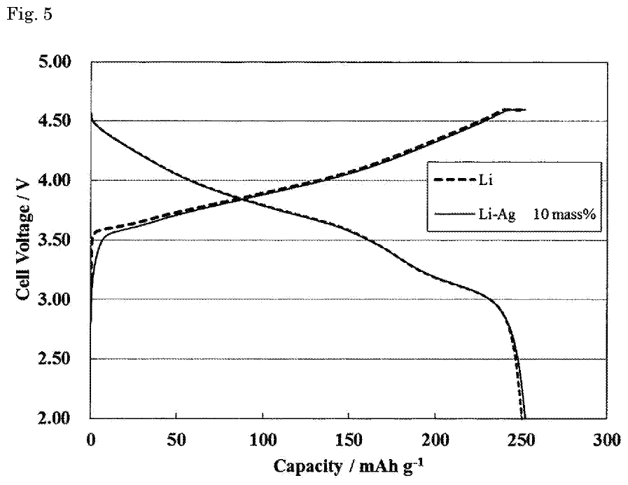

FIG. 4 shows a graph showing an amount of charge for each cycle in a charge-discharge cycle test for the nonaqueous electrolyte energy storage device according to Example 1. FIG. 5 shows the charge-discharge curves of the nonaqueous electrolyte energy storage devices according to Example 1 and Comparative Example 11 in the first cycle.

TABLE 1

| | Negative Electrode Material | | Cycle |
|---|---|---|---|
| | (Lithium Alloy or Lithium) | | Number |
| | — | Content | — |
| Example 1 | Li—Ag | Ag 10 mass % | 32.3 |
| Example 2 | | Ag 5 mass % | 28.7 |
| Comparative | | Ag 1 mass % | 24.7 |
| Example 1 | | | |
| Comparative | Li—In | In 10 mass % | 26.0 |
| Example 2 | | | |
| Comparative | | In 5 mass % | 26.3 |
| Example 3 | | | |
| Comparative | | In 1 mass % | 27.0 |
| Example 4 | | | |
| Comparative | Li—Zn | Zn 10 mass % | 26.3 |
| Example 5 | | | |
| Comparative | | Zn 5 mass % | 27.3 |
| Example 6 | | | |
| Comparative | | Zn 1 mass % | 26.3 |
| Example 7 | | | |
| Comparative | Li—Al | Al 10 mass % | 26.3 |
| Example 8 | | | |
| Comparative | | Al 5 mass % | 26.0 |
| Example 9 | | | |
| Comparative | | Al 1 mass % | 25.7 |
| Example 10 | | | |
| Comparative | Li | (Li 100 mass %) | 25.7 |
| Example 11 | | | |

As shown in Table 1 and FIG. 3, in each case of the lithium-indium alloy, the lithium-zinc alloy, and the lithium-aluminum alloy, regardless of the alloy component and content thereof, a short circuit was caused in the same number of cycles as in the case of 100% by mass of metal lithium, and no short-circuit suppression effect was produced. In contrast, in the case of the lithium-silver alloy, it has been successfully confirmed that a remarkable short-circuit suppression effect was produced by increasing the content of silver. This effect is produced only in the case of a lithium-silver alloy, and believed to be produced by a mechanism in which a fluorinated solvent and/or a lithium salt containing fluorine has some sort of influence, which is different from the invention of Patent Document 1 in which the same effect is produced regardless of the metal species in solid solution described above.

Further, charge-discharge cycle characteristics based on the number of cycles in which the discharge capacity is reduced to half with respect to the initial discharge capacity are evaluated in Patent Document 1. In contrast, in the present example, assuming that the first short circuit is caused in a cycle in which the amount of charge is clearly increased, the evaluation is performed based on the number of cycles until causing the first short circuit. Besides the short circuit caused, various factors are involved in the decrease in discharge capacity, and thus, whether the short circuit is suppressed or not can be considered indirectly evaluated in Patent Document 1. From such a viewpoint as well, the result of Patent Document 1 and the result of the example are believed to have different tendencies. More specifically, in order to suppress short circuits and increase the number of cycles until reaching the increased amount of charge, it can be considered necessary (1) to apply a lithium-silver alloy as a negative electrode in a nonaqueous electrolyte energy storage device with a fluorinated solvent used and/or (2) to apply a lithium-silver alloy as a negative electrode in a nonaqueous electrolyte energy storage device with a lithium salt containing fluorine used.

In addition, as shown in FIG. 4, in the nonaqueous electrolyte energy storage device according to Example 1, the increased amount of charge was small even after the short circuit was caused from the 31 to 33 cycles. From the foregoing, the dendrite growth at the short-circuited site is presumed to be suppressed even after the short circuit.

Comparing the first-cycle charge-discharge curves of the nonaqueous electrolyte energy storage devices according to Example 1 (lithium-silver alloy:silver content of 10% by mass) and Comparative Example 11 (metal lithium: 100% by mass) in FIG. 5 shows that the two charge-discharge curves almost coincide with other. More specifically, the nonaqueous electrolyte energy storage device according to Example 1 has a very small decrease in voltage and a very small decrease in electric capacity due to a change in negative electrode potential caused by alloying, and it has been successfully confirmed that the nonaqueous electrolyte energy storage device has a high energy density that is broadly similar to that in the case of using metal lithium. It is to be noted that typically, in the case where a lithium-silver alloy is used for a negative electrode, the oxidation-reduction potential of the alloy itself such as Li₉Ag or Li₄Ag appears as a potential that is higher than the oxidation-reduction potential of metal lithium as the content of lithium decreases with discharge. In the case where the content of silver in the lithium-silver alloy is low as in the nonaqueous electrolyte energy storage device according to Example 1, however, a Li₉Ag alloy or the like is believed to be mixed in a large amount of metal lithium, and actually, only the metal lithium is believed to react mainly, thereby resulting in almost the same voltage as that in the case where the metal lithium alone serves as a negative electrode. In addition, in the case where the metal lithium of the negative electrode contains therein silver, the electric capacity is lower than that in the case of the metal lithium alone, but in the nonaqueous electrolyte energy storage device according to Example 1, because of the low content of silver, the decrease in electric capacity can be considered also small.

### INDUSTRIAL APPLICABILITY

The present invention can be applied to a nonaqueous electrolyte energy storage device used as a power source for electronic devices such as personal computers and communication terminals, automobiles, and the like.

### DESCRIPTION OF REFERENCE SIGNS

1: nonaqueous electrolyte energy storage device
2: electrode assembly
3: case
4: positive electrode terminal
41: positive electrode lead
5: negative electrode terminal
51: negative electrode lead
20: energy storage unit
30: energy storage apparatus

1. A nonaqueous electrolyte energy storage device comprising:
a negative electrode comprising a lithium alloy; and
a nonaqueous electrolyte comprising a fluorinated solvent, wherein
the lithium alloy contains silver, and a content of silver with respect to a total content of lithium and silver in the lithium alloy is 3% by mass or more and 20% by mass or less.

2. A nonaqueous electrolyte energy storage device comprising:
a negative electrode comprising a lithium alloy; and
a nonaqueous electrolyte comprising a lithium salt containing fluorine, wherein
the lithium alloy contains silver, and a content of silver with respect to a total content of lithium and silver in the lithium alloy is 3% by mass or more and 20% by mass or less.

3. The nonaqueous electrolyte energy storage device according to claim 1, wherein a positive electrode potential at an end-of-charge voltage under normal usage is 4.30 V vs. Li/Li⁺ or more.

4. The nonaqueous electrolyte energy storage device according to claim 1, comprising a positive electrode comprising a lithium transition metal composite oxide, wherein the lithium transition metal composite oxide has an α-NaFeO₂-type crystal structure, and comprises nickel or manganese as a transition metal, and a molar ratio of lithium to the transition metal is more than 1.

5. The nonaqueous electrolyte energy storage device according to claim 1, wherein the lithium alloy is composed substantially of lithium and silver.

6. A method for manufacturing a nonaqueous electrolyte energy storage device, the method comprising:
preparing a negative electrode comprising a lithium alloy; and
preparing a nonaqueous electrolyte comprising a fluorinated solvent, wherein
the lithium alloy contains silver, and a content of silver with respect to a total content of lithium and silver in the lithium alloy is 3% by mass or more and 20% by mass or less.

7. A method for manufacturing a nonaqueous electrolyte energy storage device, the method comprising:
preparing a negative electrode comprising a lithium alloy; and
preparing a nonaqueous electrolyte comprising a lithium salt containing fluorine, wherein
the lithium alloy contains silver, and a content of silver with respect to a total content of lithium and silver in the lithium alloy is 3% by mass or more and 20% by mass or less.

8. The nonaqueous electrolyte energy storage device according to claim 2, wherein a positive electrode potential at an end-of-charge voltage under normal usage is 4.30 V vs. Li/Li⁺ or more.

9. The nonaqueous electrolyte energy storage device according to claim 2, comprising a positive electrode comprising a lithium transition metal composite oxide, wherein the lithium transition metal composite oxide has an α-NaFeO₂-type crystal structure, and comprises nickel or manganese as a transition metal, and a molar ratio of lithium to the transition metal is more than 1.

10. The nonaqueous electrolyte energy storage device according to claim 2, wherein the lithium alloy is composed substantially of lithium and silver.
